(19) United States
(12) Patent Application Publication
(10) Pub. No.: US 2007/0198394 A1
(43) Pub. Date: Aug. 23, 2007

(54) Method and system for auctioning commodities & futures using a full-time public network

(76) Inventor: Mark H. Springer, Thousand Oaks, CA (US)

Correspondence Address: HULSEY IP INTELLECTUAL PROPERTY LAWYERS, P.C., 1250 S. CAPITAL OF TEXAS HIGHWAY, BUILDING THREE, SUITE 610, AUSTIN, TX, 78746, US

(21) Appl. No.: 11/359,058

(22) Filed: Feb. 22, 2006

(51) Int. Cl. G06Q 40/00

(52) U.S. Cl. 705/37

(57) ABSTRACT

A method for auctioning commodities & futures to a trading house or by a trader using a full-time public network, including several steps. A connection is established (160) to a full-time public network. Trading house or trader criteria received via the full-time public network is accepted (162). Risk analytics is performed (164) to facilitate identification of acceptable bidders. At least one bid is accepted (166) from at least one acceptable bidder via the full-time public network. Each accepted bid is evaluated (168) based on the trading house or trader criteria to determine whether the bid satisfies the criteria. At least one bid is selected (170) as a winning bid determined to satisfy the trading house or trader criteria. A system for matching traders and trading houses includes at least one trader computing system (212), at least one trading house computing system (216), and auctioneer computing system (218) having several operating modules.

### CROSS-REFERENCE TO RELATED APPLICATION

This application claims the benefit of priority to U.S. Provisional Patent Application No. 10/830,694 entitled “METHOD AND SYSTEM FOR AUCTIONING FUNDS USING A FULL-TIME PUBLIC NETWORK,” filed on Apr. 23, 2004, and is incorporated herein by reference in its entirety.

### FIELD OF THE DISCLOSURE

This disclosure pertains to electronic commerce. More particularly, this disclosure pertains to a method and system for auctioning commodities & futures using a full-time public network.

### BACKGROUND OF THE DISCLOSURE

A futures contract is a legally binding agreement to buy or sell a commodity or financial instrument sometime in the future at a price agreed upon at the time of the trade. The standardization of futures contracts affords tremendous flexibility. Because futures contracts are standardized, sellers and buyers can exchange one contract for another and “offset” their obligation to take delivery on a commodity or instrument underlying the futures contract.

One of the key benefits of trading in the futures markets is that it offers the trader financial leverage. Leverage is the ability of a trader to control large dollar amounts of a commodity with a comparatively small amount of capital. The benefit of leverage is available because of the margin concept. When the purchaser buy a stock, the amount of money required is equal to the price of the stock. To trade a futures contract, the amount the purchaser must deposit in the purchaser's account is called initial margin. Another key benefit of futures trading is liquidity. Liquidity is a characteristic of a market to absorb large transactions without a substantial change in the price. Liquid markets easily match a buyer with a seller, enabling traders to quickly transact their business at a fair price.

Some traders often equate liquidity with trading volume, concluding that only markets with the highest actual number of contracts traded are the most liquid. However, for some contracts, the Chicago Board of Trade has a market maker system in place to promote liquidity. For contracts with a market maker, a trader or firm designated as the market maker then makes two-sided markets (both bids and offers) for a specific quantity.

Many futures markets such as those at the CBOT are considered to be “transparent” because the order flow is open and fair. Everyone has an equal opportunity for the trade. When an order enters the marketplace, the order fills at the best price for the customer, regardless of the size of the order. With the advent of electronic trading, transparency has reached new heights as all transactions can be viewed online in real time. In a very general sense, transparency makes all market participants equal in terms of market access.

When making an investment, it is important to have confidence that the person on the other end of the trade will acknowledge and accept the purchaser's transaction. Futures markets give the purchaser this confidence through a clearing service provider system that guarantees the integrity of the purchaser's trades.

Traders play a vital role in the futures markets by providing liquidity. While futures are designed primarily to assist hedgers in managing their exposure to price risk, the market would not be possible without the participation of traders, or speculators, who provide a fluid market of buyers and sellers. Speculators provide the bulk of market liquidity, which allows the hedger to enter and exit the market in a more efficient manner. Futures traders can also be categorized in a number of other ways.

There are full-time professional traders and part-time traders; traders who trade on the trading floor or behind a computer screen. Each of these market participants plays an important role in making the markets efficient places to conduct business. For all of these types of traders, a method and system for auctioning commodities and futures using a full-time public network would be of importance and significant benefit. Accordingly, this disclosure provides a method and system that achieves auctioning commodities and futures using a full-time public network. The advantages, as well as additional inventive features, of such a system will be apparent from reading from the disclosure provided herein.

### BRIEF DESCRIPTION OF THE DRAWINGS

For a more complete understanding of the present disclosure, and the advantages thereof, reference is now made to the following brief descriptions taken in conjunction with the accompanying drawings, in which like reference numerals indicate like features.

FIG. 1 illustrates a general purpose computing system that may be part of a network of such computing systems for employing the method and system for auctioning commodities & futures using a full-time public network in an embodiment of the present disclosure.

FIG. 2 shows the steps of a method for auctioning commodities & futures to a trading house using a full-time public network, in accordance with an embodiment of the present disclosure.

FIG. 3 depicts the components of exemplary trading house criteria, in accordance with an embodiment of the present disclosure.

FIG. 4 overviews a method for auctioning commodities & futures by a trader using a full-time public network, in accordance with an embodiment of the present disclosure.

FIG. 5 characterizes the components of exemplary trader criteria, in accordance with an embodiment of the present disclosure.

FIG. 6 delineates an electronically connected network illustrating an environment capable of supporting the method and system of the present disclosure for auctioning commodities & futures using a full-time public network in an embodiment of the present disclosure.

FIG. 7 represents an auctioneer computing system having several operating modules, in accordance with an embodiment of the present disclosure.

FIG. 8 portrays an overview of an auction process, in accordance with an embodiment of the present disclosure.

FIG. 9 describes a trader-oriented auction process, in accordance with an embodiment of the present disclosure.

FIG. 10 illustrates a standard-term auction process detail, in accordance with an embodiment of the present disclosure.

FIG. 11 overviews establishment of a standing bid by a trading house, in accordance with an embodiment of the present disclosure.

FIG. 12 characterizes differences between an auction process for standard term trades and an auction process for custom term trades, in accordance with an embodiment of the present disclosure.

FIG. 13 shows a trader process for a standard trade auction, in accordance with an embodiment of the present disclosure.

FIG. 14 portrays a trading house process for a standard trade auction, in accordance with an embodiment of the present disclosure.

FIG. 15 depicts an auctioneer process for a standard trade auction, in accordance with an embodiment of the present disclosure.

FIG. 16 delineates spreading of commodities & futures by a trader across several trading houses, in accordance with an embodiment of the present disclosure.

FIG. 17 represents facilitation of a trade auction for a custom term trade, in accordance with an embodiment of the present disclosure.

FIG. 18 describes an alternate approach to obtaining similar results to the representation of FIG. 17, in accordance with an embodiment of the present disclosure.

FIG. 19 shows a process for auctioning trading house trade opportunities to traders, in accordance with an embodiment of the present disclosure.

### DETAILED DESCRIPTION OF THE DISCLOSURE

The disclosure provides a method and system of auctioning commodities & futures via a full-time public network. Other aspects, objectives and advantages of the disclosure will become more apparent from the remainder of the detailed description when taken in conjunction with the accompanying drawings. A further potential benefit of many embodiments of the present disclosure is that the traders and trading houses having been matched to each other would have reason to enjoy improved confidence that transaction execution has been satisfactory. This differs from current practice in which only the broker between the trader and trading house truly knows the quality of execution.

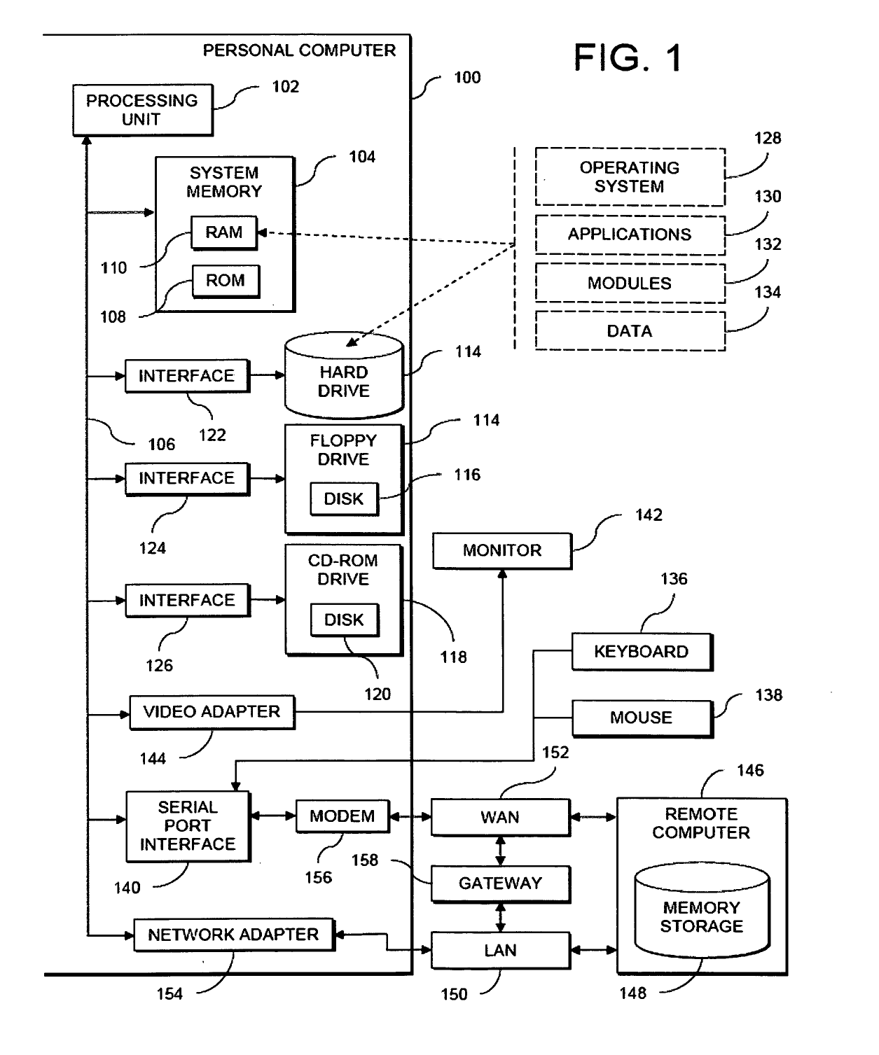

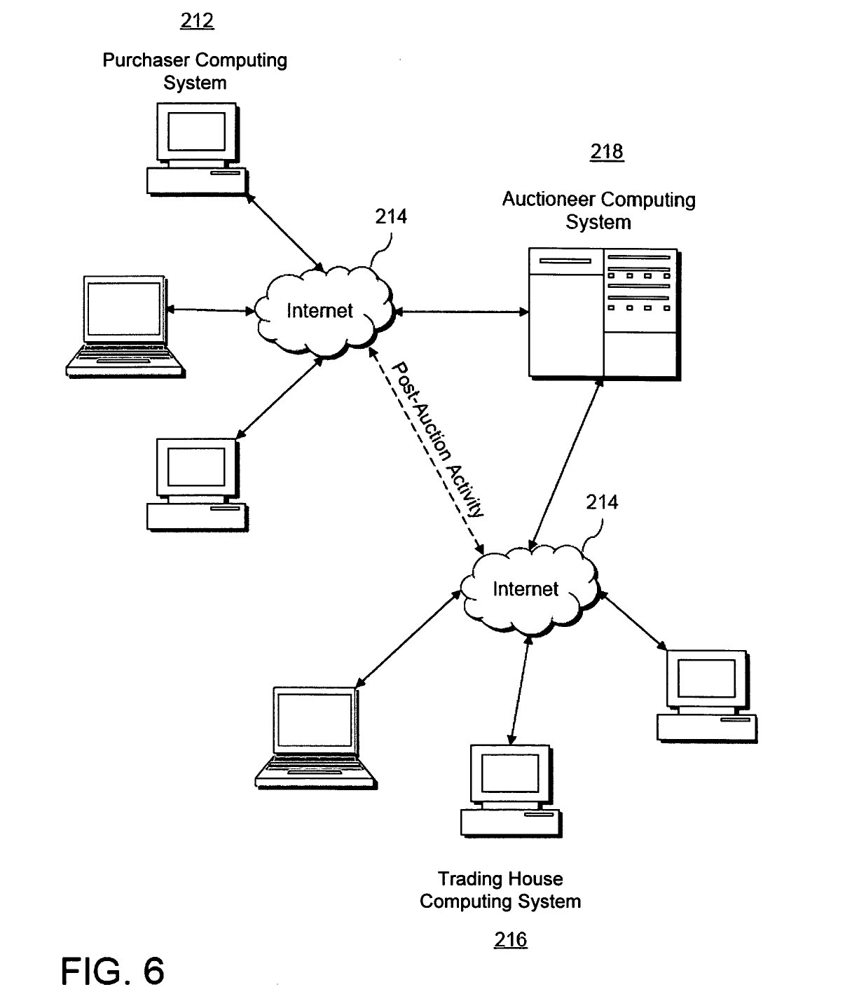

FIG. 1 illustrates a general purpose computing system that may be part of a network of such computing systems for employing the present disclosure's method and system for auctioning commodities & futures using a full-time public network. By associating a network of general-purpose computers 100, an example of which appears below in FIG. 6, the present disclosure facilitates automatic on-line matching of transactions using an auction-based protocol over a full-time public network. In such an electronic conveyancing environment as established by the present disclosure, at least two such computers may be operated at different locations within a given geographical or similarly bounded area.

With reference to FIG. 1, general-purpose computer 100 may be a personal computer, a laptop, palmtop, or other set top, server, mainframe, and other variety computer, and include processing unit 102, system memory 104, and system bus 106 coupling various system components including system memory 104 to the processing unit 102. Processing unit 102 may be any of various commercially available processors, including Intel x86, Pentium® and compatible microprocessors from Intel® and others, including Cyrix®, AMD® and Nexgen®; MIPS® from MIPS Technology®, NEC®, Siemens®, and others; and the PowerPC® from IBM and Motorola. Dual microprocessors and other multi-processor architectures also can be used as the processing unit 102. System bus 106 may be any of several types of bus structures including a memory bus or memory controller, a peripheral bus, and a local bus using any of a variety of conventional bus architectures such as PCI, VESA, AGP, Microchannel, ISA and EISA, to name a few. System memory 104 includes read only memory (ROM) 108 and random access memory (RAM) 110. A basic input/output system (BIOS), containing the basic routines helping to transfer information between elements within the computer 100, such as during start-up, is stored in ROM 108.

Computer 100 further includes a hard disk drive 112, a floppy drive 114, e.g., to read from or write to a removable disk 116, and CD-ROM drive 118, e.g., for reading a CD-ROM disk 120 or to read from or write to other optical media. The hard disk drive 112, floppy drive 114, and CD-ROM drive 118 are connected to the system bus 106 by a hard disk drive interface 122, a floppy drive interface 124, and an optical drive interface 126, respectively. The drives and their associated computer-readable media provide nonvolatile storage of data, data structures, computer-executable instructions, etc., for computer 100. Although the description of computer-readable media provided above refers to a hard disk, a removable floppy and a CD, those skilled in the art may appreciate other types of media which are readable by a computer, such as magnetic cassettes, flash memory cards, digital video disks, Bernoulli cartridges, and the like, being used in the exemplary operating environment.

A number of program modules may be stored in the drives and RAM 110, including an operating system 128, one or more application programs 130, other program modules 132, and program data 134. A consumer may enter commands and information into the computer 100 through a keyboard 136 and pointing device, such as mouse 138. Other input devices (not shown) may include a microphone, joystick, game pad, satellite dish, scanner, or the like. These and other input devices are often connected to the processing unit 102 through a serial port interface 140 coupling to the system bus, but possibly connecting by other interfaces, such as a parallel port, game port or a universal serial bus (USB). A monitor 142 or other type of display device is also connected to the system bus 106 via an interface, such as a video adapter 144. In addition to the monitor, computers typically include other peripheral output devices (not shown), such as speakers and printers.

Computer 100 may operate in a networked environment using logical connections to one or more remote computers, such as a remote computer 146. Remote computer 146 may be a server, a router, a peer device or other common network node, and typically includes many or all of the elements described relative to the computer 100, although only a memory storage device 148 has been illustrated in FIG. 1. The logical connections depicted in FIG. 1 include a local area network (LAN) 150 and a wide area network (WAN) 152. Such networking environments are commonplace in offices, enterprise-wide computer networks, intranets and the Internet.

When used in a LAN networking environment, the computer 100 is connected to the LAN 150 through a network interface or adapter 154. When used in a WAN networking environment, computer 100 typically includes a modem 156 or other means for establishing communications (e.g., via the LAN 150 and a gateway or proxy server) over the wide area network 152, such as the Internet. Modem 156, which may be internal or external, is connected to the system bus 106 via the serial port interface 140. In a networked environment, program modules depicted relative to the computer 100, or portions thereof, may be stored in the remote memory storage device 148.

Those skilled in the art may appreciate the network connections shown as being exemplary, wherein other means of establishing a communications link between the computers may be used. FIG. 1 only provides one example of a computer useful for employing the teachings of the present disclosure. The disclosure may be used in computers other than general-purpose computers, as well as on general-purpose computers without conventional operating systems.

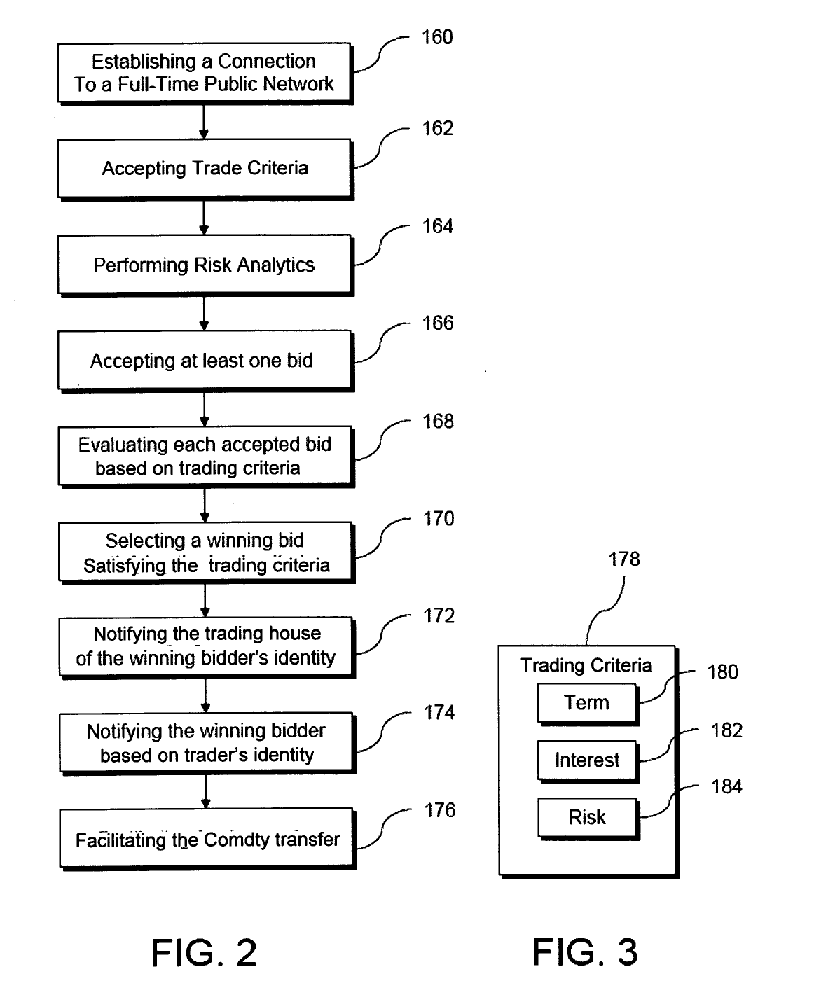

FIG. 2 depicts a method for auctioning commodities & futures to a trading house using a full-time public network, including several steps. A connection is established 160 to a full-time public network. Trading house criteria received via the full-time public network is accepted 162. Risk analytics is performed 164 to facilitate identification of acceptable bidders. At least one bid is accepted 166 from at least one acceptable bidder via the full-time public network. Each accepted bid is evaluated 168 based on the trading house criteria to determine whether the bid satisfies the criteria. At least one bid is selected 170 as a winning bid determined to satisfy the trading house criteria. The trading house is notified 172 of the winning bidder's identity. The winning bidder is notified 174 of the trading house's identity. The transfer of commodities & futures from the winning bidder to the trading house is facilitated 176 according to the terms of the trading house criteria and the winning bid.

FIG. 3 depicts the components of exemplary trading house criteria 178, in accordance with an embodiment of the present disclosure. The trading house criteria 178 include a term 180, a range of acceptable interest rates 182, and information pertaining to acceptable risk 184. The identity of all participants can be maintained as confidential during the auction. This can provide value to the participants who do not wish others to know of their auction participation activities. For example, trading houses often have a vested interest in keeping auction activity confidential from competing institutions as proprietary business information. This process reasonably protects the anonymity of all parties involved. Accordingly, this market mechanism can offer complete anonymity to all participants until such time as there is a winning bid. None of the participating trading houses will know what other participating trading houses (i.e., competitors) are offering to win bids. Moreover, participating trading houses will be unaware of which participant is winning a given auction, which may benefit traders by translating into higher interest rates paid.

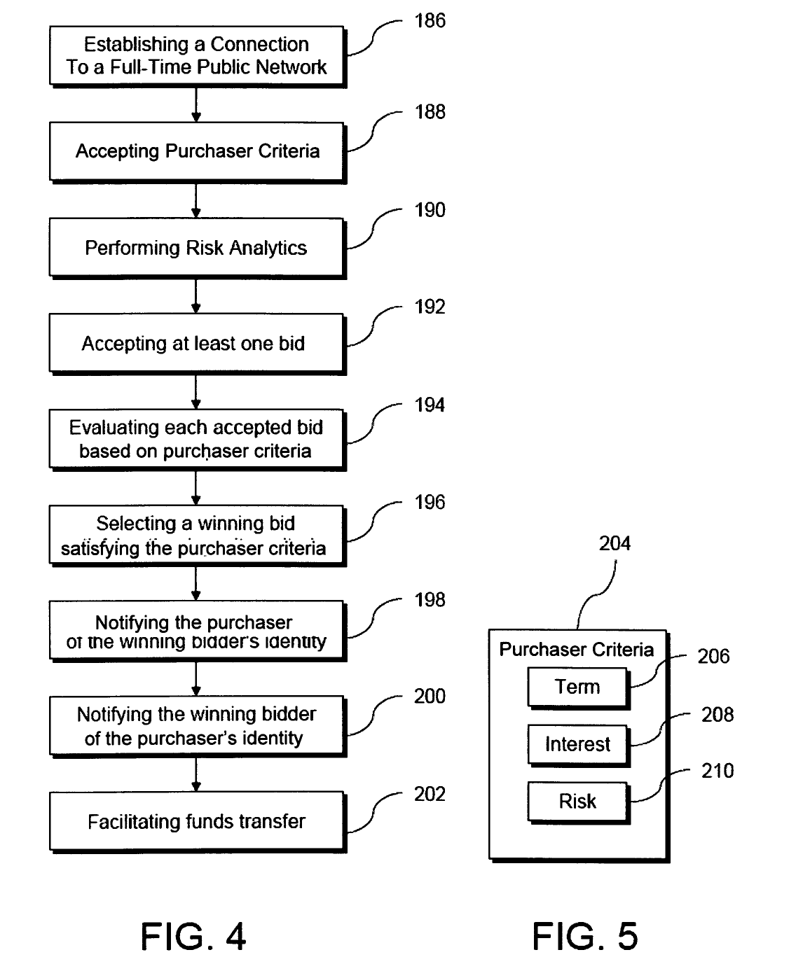

FIG. 4 depicts a method for auctioning commodities & futures by a trader using a full-time public network, including several steps. A connection is established 186 to a full-time public network. Trader criteria received via the full-time public network is accepted 188. Risk analytics is performed 190 to facilitate identification of acceptable bidders. At least one bid is accepted 192 from at least one acceptable bidder via the full-time public network. Each accepted bid is evaluated 194 based on the trader criteria to determine whether the bid satisfies the criteria. At least one bid is selected 196 as a winning bid determined to satisfy the trader criteria. The trader is notified 198 of the winning bidder's identity. The winning bidder is notified 200 of the trader's identity. The transfer of commodities & futures from the trader to the winning trading house is facilitated 202 according to the terms of the trader criteria and the winning bid.

FIG. 5 depicts the components of exemplary trader criteria 204, in accordance with an embodiment of the present disclosure. The trader criteria 204 includes a term 206, a range of acceptable interest rates 208, and information pertaining to acceptable risk 210. Some embodiments allow the trade criteria to be non-standard compared to typical industry practices, in which case member trading houses may be apprised of the non-standard trade criteria.

For example, standard trade criteria could include terms divisible by 30 days, such as 30 days, 60 days, 90 days, etc. If so, trade criteria specifying 45 days would be non-standard. In addition, the step of accepting at least one bid from at least one acceptable bidder via the full-time public network may include reviewing at least one unfulfilled standing bid to determine whether the unfulfilled standing bid satisfies the trade criteria and automatically accepting unfulfilled standing bids that satisfy the trade criteria.

FIG. 6 delineates an electronically connected network illustrating an environment capable of supporting the method and system of the present disclosure for auctioning commodities & futures using a full-time public network in an embodiment of the present disclosure. The system of FIG. 6 for auction-based transactional matching of traders and trading houses in order to achieve qualified placement of commodities & futures so as to satisfy the criteria of trader and trading house has several components. The system includes at least one trader computing system 212 adapted to communicably couple to an auctioneer computing system 218 via the full-time public network 214. The system also includes at least one trading house computing system 216 adapted to communicably couple to the auctioneer computing system 218 via the full-time public network 214.

Furthermore, as shown in FIG. 6, the at least one trader computing system 212 is adapted to communicably couple to the at least one trading house computing system 216 following conclusion of the auction-based match in order to execute post-auction activity in accordance with the terms of the trader criteria and the trading house criteria.

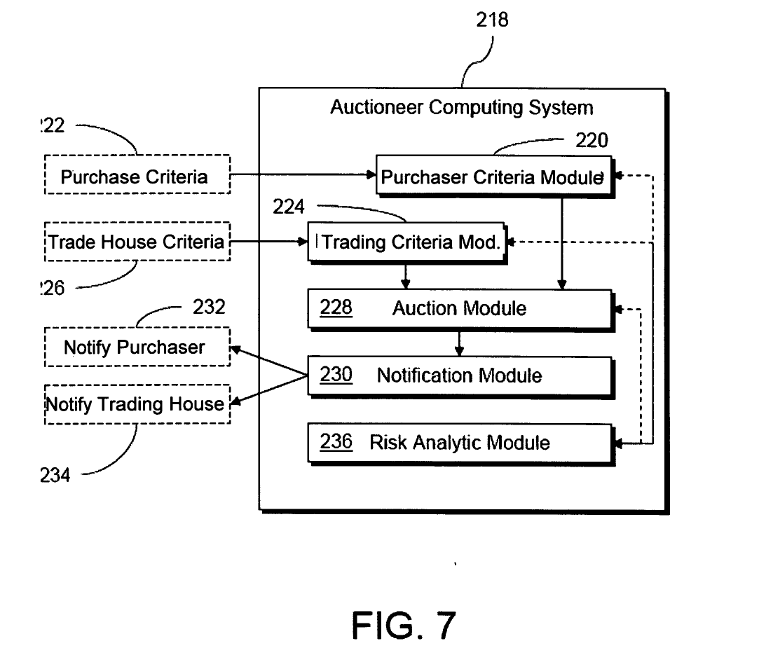

FIG. 7 represents the auctioneer computing system 218 having several operating modules, in accordance with an embodiment of the present disclosure. A trader criteria module 220 is adapted to accept trader criteria 222 from potential traders via the full-time public network. A trading house criteria module 224 is adapted to accept trading house criteria 226 from potential traders via the full-time public network. An auction module 228 is adapted to perform an auction-based transactional matching of accepted trader criteria to accepted trading house criteria, wherein each criteria satisfies the requirements of the criteria to which it is matched. A notification module 230 is adapted to notify, in response to the matching of an accepted trader criteria with an accepted trading house criteria, the corresponding trader 232 and the corresponding trading house 234 of the match via the full-time public network.

The auctioneer computing system of FIG. 7 may further include a risk analytic module 236 adapted to perform risk analytics on accepted trader criteria 222 and accepted trading house criteria 226 in order to facilitate matching. The risk analytic module may include computer-readable instructions, the execution of which causes performance of risk analytics on accepted trader criteria 222 and accepted trading house criteria 226 in order to facilitate matching.

The trader criteria module 220 shown in FIG. 7 may include computer-readable instructions, the execution of which causes acceptance of trader criteria 222 from potential traders via the full-time public network. The trading house criteria module 224 may include computer-readable instructions, the execution of which causes acceptance of trading house criteria 226 from potential traders via the full-time public network.

The auction module 228 may include computer-readable instructions, the execution of which causes performance of an auction-based transactional matching of accepted trader criteria 222 to accepted trading house criteria 226, wherein each criteria satisfies the requirements of the criteria to which it is matched.

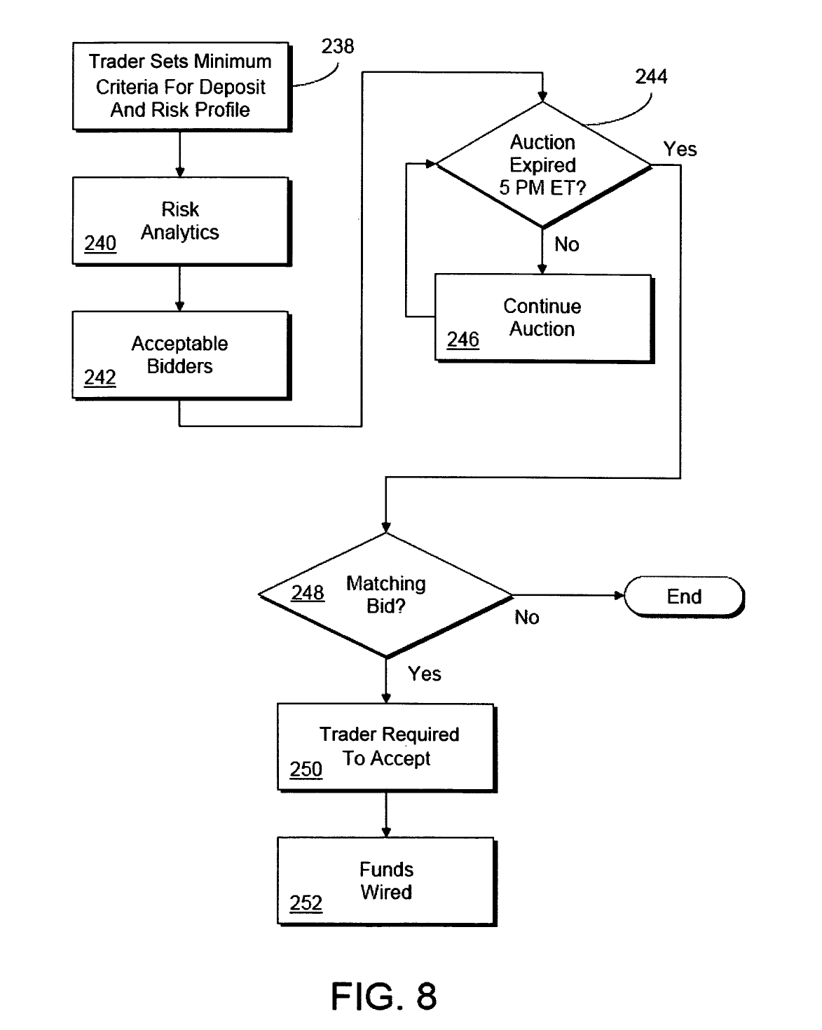

FIG. 8 portrays an overview of an auction process, in accordance with an embodiment of the present disclosure. Initiating the process, a trading house sets minimum criteria 238 in order to establish a trade and risk profile. Risk analytics are performed 240 in order to facilitate matching of the trade and risk profile of the trading house to trader bids. Acceptable bidders are allowed to bid 242 on the trading house profile so long as the auction is not expired, typically at 5 p.m. Eastern Time 244. The auction continues 246 until it expires. If no matching bids 248 are forthcoming, the auction process ends without a match having been made. Otherwise, the trading house is required to accept 250 the winning trader's bid, and the trader's commodities & futures are wired 252 to the trading house.

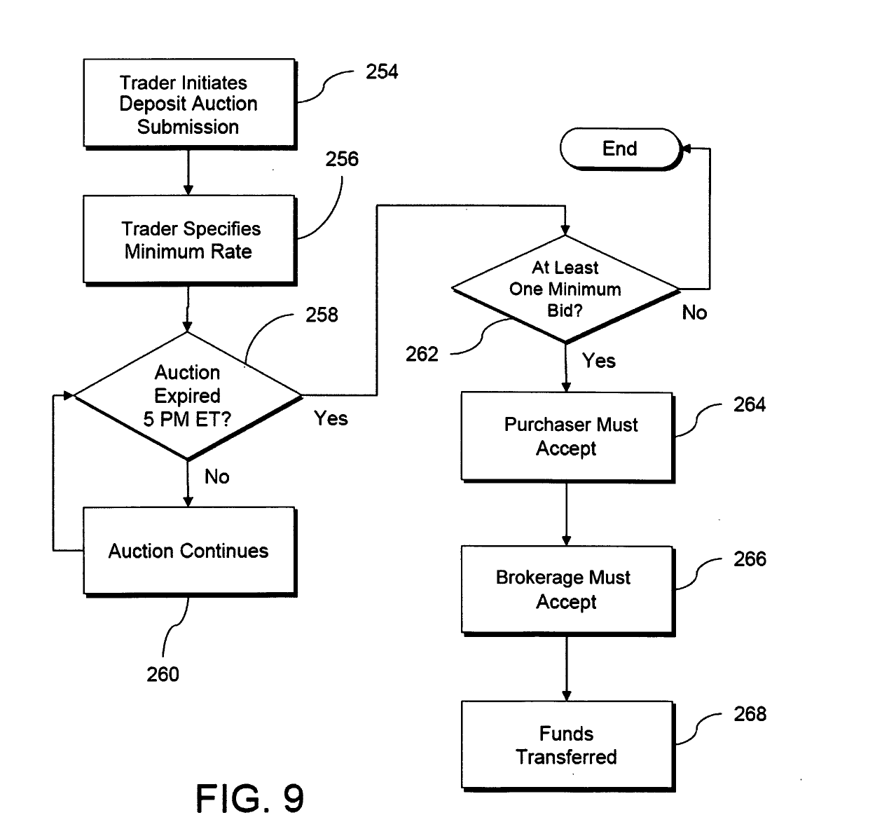

FIG. 9 describes a trader-oriented auction process, in accordance with an embodiment of the present disclosure. Initially, a trading house initiates 254 a trade auction submission. Subsequently, the trading house specifies a minimum acceptable rate of interest 256. So long as the auction is unexpired 258, the auction continues 260. Once the auction has expired, if there has not been at least one minimum bid 262, the auction ends without a match. Otherwise, the trader must accept 264 the winning trading house bid. Likewise, the winning trading house must accept 266 the terms of its bid. Subsequently the trader's commodities & futures are transferred 268 to the winning trading house.

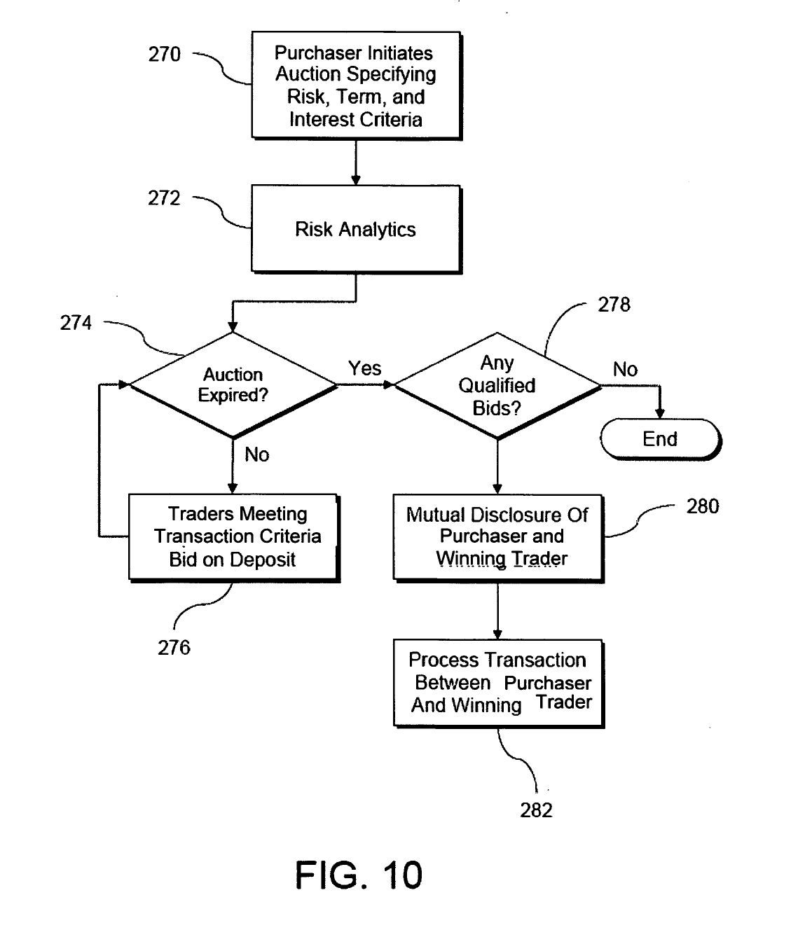

FIG. 10 illustrates a standard-term auction process detail, in accordance with an embodiment of the present disclosure. A trader initiates 270 the auction, specifying all relevant criteria, including acceptable risk information, term, and interest rate range. Risk analytics 272 are performed to facilitate suitable matching of trader and trading house. So long as the auction is unexpired 274, trading houses meeting 276 the trader criteria are able to bid on the trade being auctioned. Upon expiration of the auction, if no qualified bids have been entered 278, the auction ends without having matched the trader to a trading house. Otherwise, mutual disclosure of identity occurs 280 between the trader and the winning trading house. Until that time, the identity of the trade poster and the identity of the bidding trading houses remains confidential. Finally, the transaction between the trader and the winning trading house is processed 282.

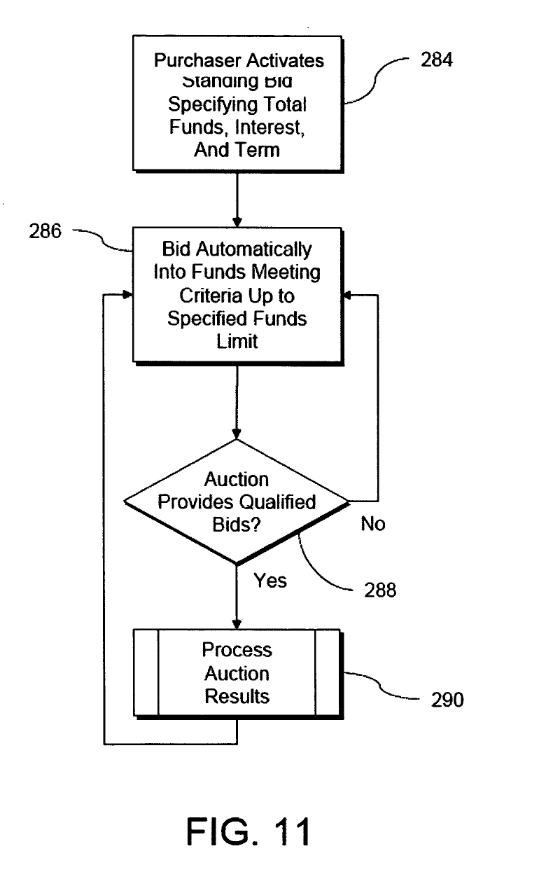

FIG. 11 overviews establishment of a standing bid by a trading house, in accordance with an embodiment of the present disclosure. A trading house activates 284 a standing bid, specifying the total amount of commodities & futures being sought, acceptable interest rate limitations, and term. The standing bid causes the trading house to bid automatically 286 into trader commodities & futures being auctioned which meet the trading house's standing bid criteria up to the specified limitation of trading house commodities & futures available for satisfying the standing bid. If the auction does not provide 288 qualified bids, the standing bid continues to cause the trading house to bid automatically 286 into trader commodities & futures being auctioned which meet the trading house's standing bid criteria up to the specified limitation of trading house commodities & futures available for satisfying the standing bid. If the auction does provide 288 a qualified bid, then the auction results are processed 290, the specified limitation of trading house commodities & futures available for satisfying the standing bid is revised downward an amount corresponding to the winning bid, and, if trading house commodities & futures remain available to satisfy the standing bid, the standing bid causes the trading house to bid automatically 286 into trader commodities & futures being auctioned which meet the trading house's standing bid criteria up to the remaining limitation of trading house commodities & futures available for satisfying the standing bid.

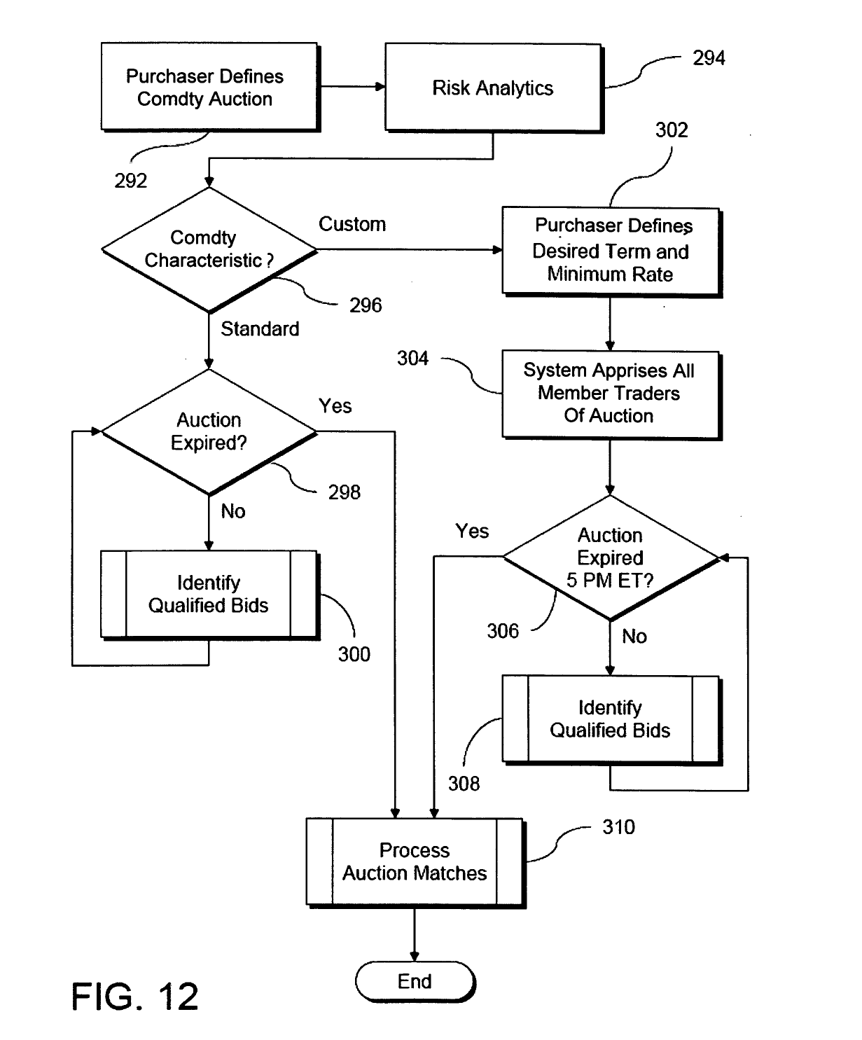

FIG. 12 characterizes differences between an auction process for standard term trades and an auction process for custom term trades, in accordance with an embodiment of the present disclosure. A trader defines 292 a trade auction. Risk analytics are performed 294 to facilitate matching. If the trade characteristics are standard 296, then so long as the auction is unexpired 298, qualified bids are identified 300. Once the auction expires 298, auction matches are processed 310.

If, in FIG. 12, the trade characteristics are custom 296, i.e., non-standard, the trader defines 302 a desired term and minimum interest rate. The system then apprises 304 all member trading houses of the auction, so the member trading houses can formulate bids, if desired. While the auction lasts 306, qualified bids are identified 308. Upon completion of the auction 306, auction matches are processed 310.

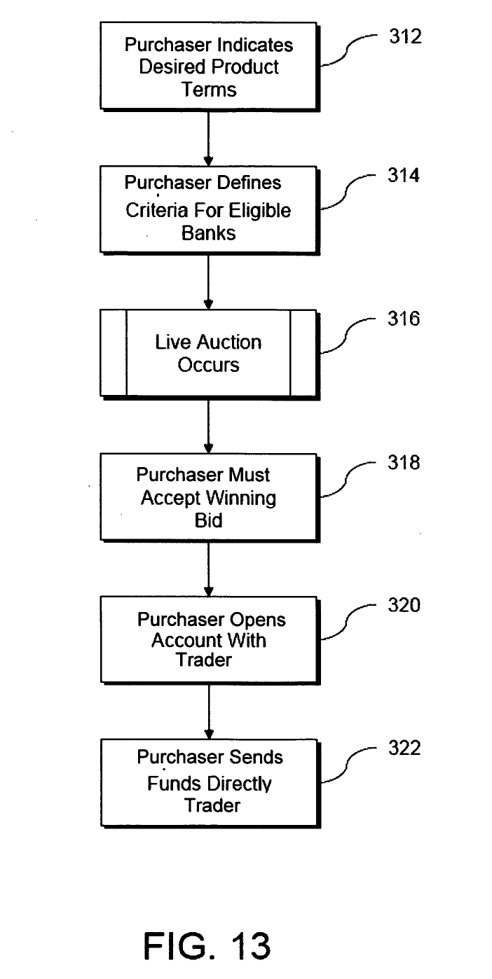

FIG. 13 shows a trader process for a standard trade auction, in accordance with an embodiment of the present disclosure. The trader indicates 312 desired product terms. The trader defines 314 criteria for eligible trading houses. A live auction then occurs 316, resulting in a match. The trader must accept 318 the winning bid. The trader consequently opens an account 320 with the winning trading house, and the trader sends 322 corresponding commodities & futures directly to the winning trading house.

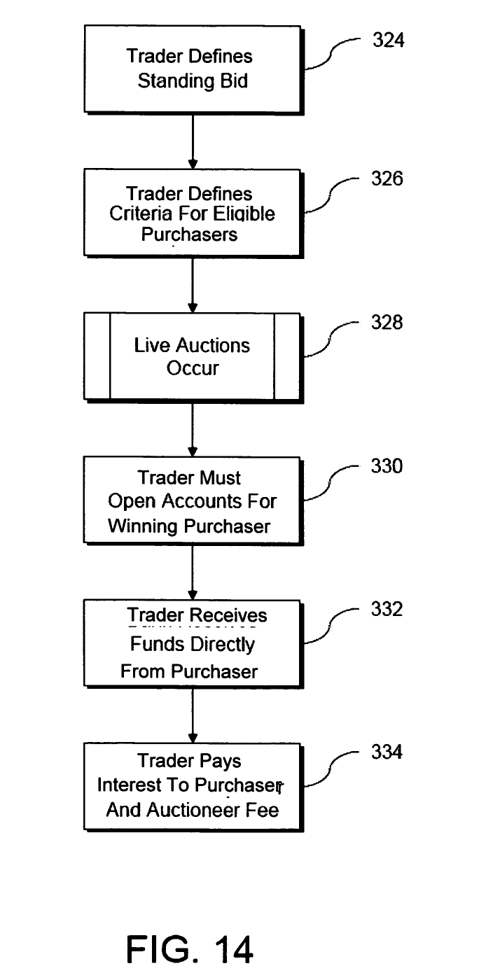

FIG. 14 portrays a trading house process for a standard trade auction, in accordance with an embodiment of the present disclosure. The trading house defines 324 a standing bid. The trading house defines 326 criteria for eligible traders. For example, the trading house may wish to avoid cannibalizing customers from its retail trading house branches in specific geographic areas. In that case, traders in those geographic areas will not be eligible to bid. The live auction occurs 328, resulting in a match. The trading house must open accounts 330 for the winning trader. The trading house receives commodities & futures 332 directly from the trader. Finally, the trading house pays interest 334 to the trader and an auctioneer fee to the auctioneer.

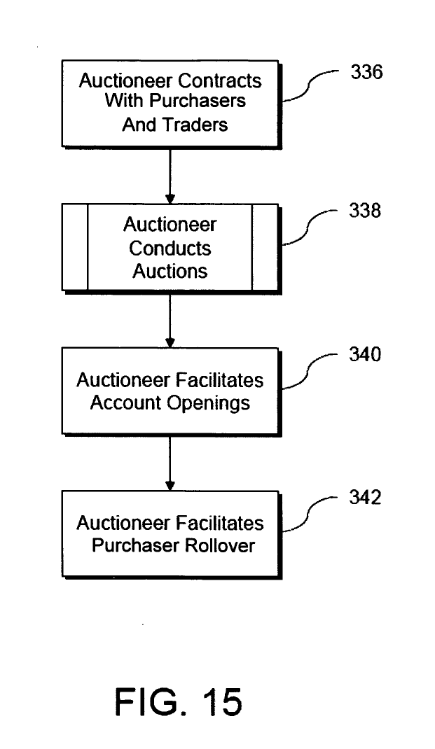

FIG. 15 depicts an auctioneer process for a standard trade auction, in accordance with an embodiment of the present disclosure. An auctioneer contracts 336 with traders and trading houses, binding each to accept resulting matches that meet the auctioning party's defined criteria and that meet the bidding party's bid terms. The auctioneer then conducts 338 auctions, after the successful conclusion of which, the auctioneer facilitates 340 account openings and facilitates 342 trader rollovers.

The following examples further illustrate the disclosure but, of course, should not be construed as in any way limiting its scope.

### EXAMPLE 1

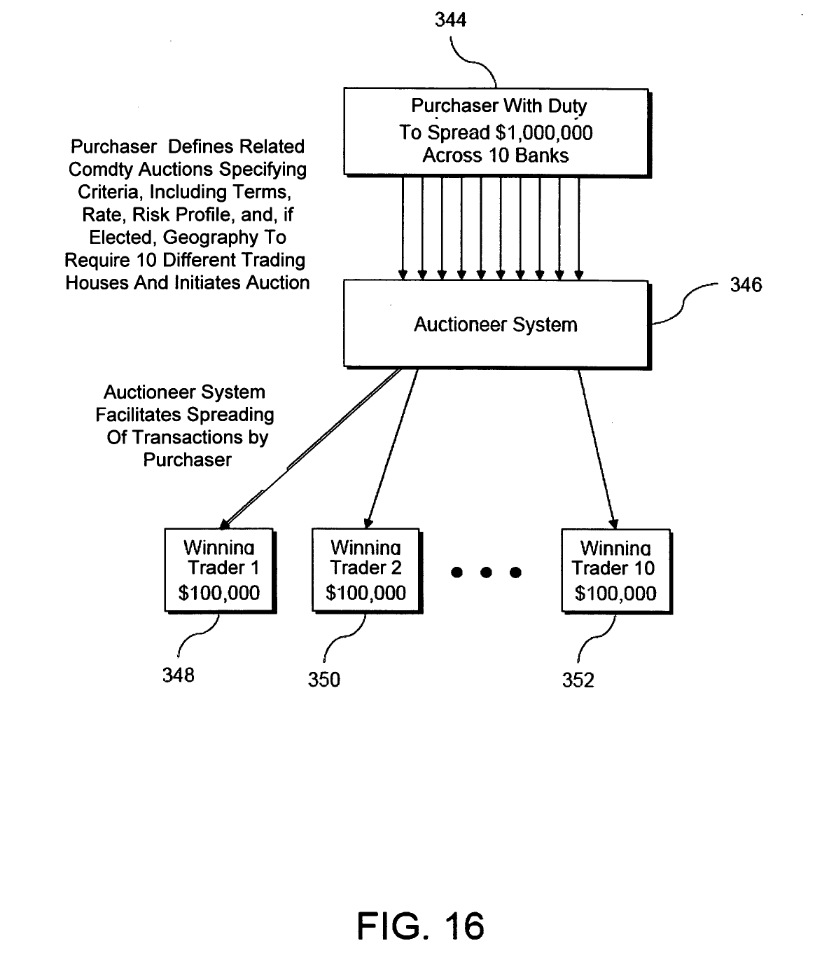

FIG. 16 delineates spreading of commodities & futures by a trader across several trading houses, in accordance with an embodiment of the present disclosure. This is but one example of the ability of the claimed method and system of the present disclosure to meet the customized needs of particular traders and particular trading houses. In this example, a trader has $1,000,000 to trade. The trader also has a duty to spread these commodities & futures across ten trading houses. While there are many alternate approaches the trader could use within the claimed method and system of the present disclosure in order to achieve this result, in FIG. 16, the trader elects to define related trade auctions, specifying corresponding criteria, including terms, rate, risk profile to require ten different trading houses to match the trades, so that no two trades would need to be made with the same trading house. Note that the trader would also have the option of specifying geography or any other relevant characteristic of the trade that the trader desired to make part of the trade criteria. The auctioneer system 346 makes the appropriate matches, if appropriate trading house bids are forthcoming, matching the commodities & futures in $100,000 increments, as specified by the trader, to ten trading houses 348, 350, . . . , and 352.

### EXAMPLE 2

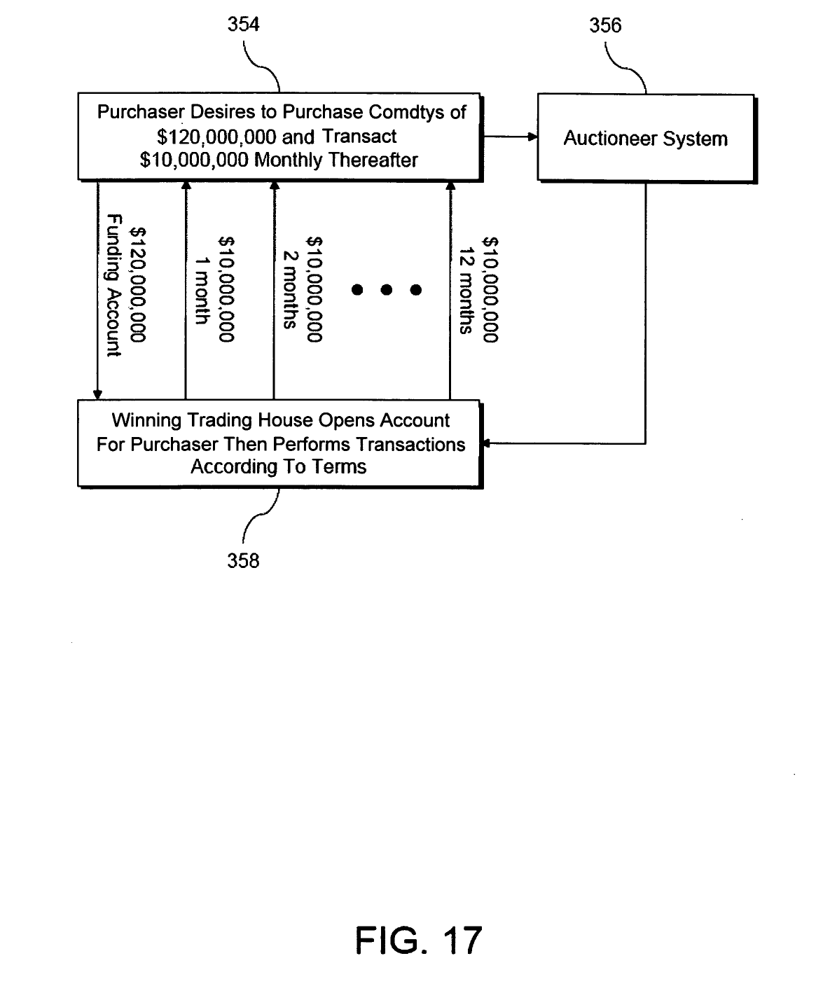

FIG. 17 represents facilitation of a trade auction for a custom term trade, in accordance with an embodiment of the present disclosure. This shows a second example: one in which the trader 354 wishes to place $120,000,000 with a single trading house and receive back 1/12th of that amount each month for 12 months. The trader defines the custom trade criteria, and the auctioneer system 356 processes the auction accordingly. If a winning bid is ascertained, the winning trading house 358 opens an account for the trader and then disburses the commodities & futures according to the specified terms of the trade criteria and the winning bid. Therefore, the trader would first fund the account with $120,000,000. Subsequently, the trading house would make a monthly transfer of $10,000,000 to the trader.

### EXAMPLE 3

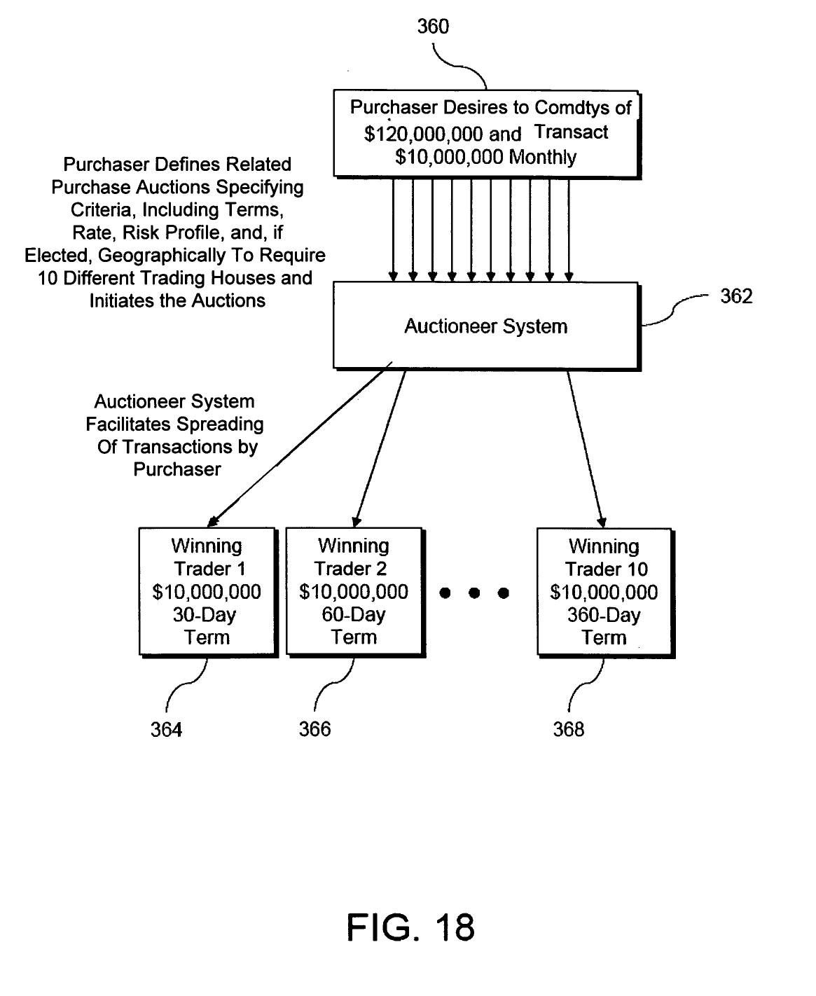

FIG. 18 describes an alternate approach to obtaining similar results to the representation of FIG. 17, in accordance with an embodiment of the present disclosure. In this third example, the trader 360 not only desires to place a single trade for $120,000,000 and receive back 1/12th each month, but also wishes to place no more than $10,000,000 with any single trading house. Therefore, the trader 360 defines the custom trade criteria accordingly, and that auctioneer system 362 processes the auction. If corresponding matches are made with twelve trading houses 364, 366, . . . , and 368, auctioneer system 362 processes the matches accordingly, requiring the trader and trading houses to close the transactions in accordance with the terms of the trade criteria and relevant bids.

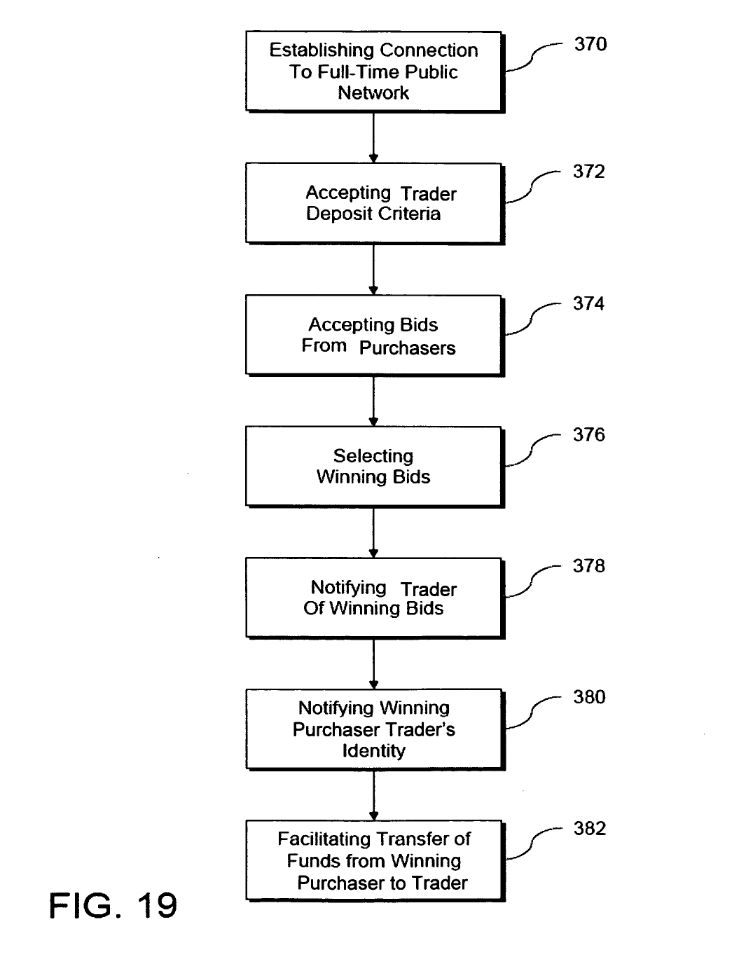

FIG. 19 shows a method for auctioning trading house trade opportunities to traders using a full-time public network. In the shown embodiment, the trading house establishes a connection to a full-time public network is established 370. Trading house trade criteria are accepted 372 from the trading house via the full-time public network. The trade criteria include a trade amount, a trade term, and a maximum specified interest rate. At least one bid is accepted 374 from at least one trader via the full-time public network, the bid including a bid interest rate no more than the maximum specified interest rate. At least one winning bid is selected 376 from the accepted bids on the basis of its bid interest rate. The trading house is notified 378 of the winning bid, including the identity of the winning bidder and the winning bid interest rate. The winning trader can be notified 380 of the trading house's identity. The transfer of commodities & futures from the winning trader to the trading house can be facilitated 382 to fulfill the trading house trade opportunity according to the terms of the trading house trade criteria and the winning bid.

The process depicted in FIG. 19 allows each trading house that wishes to attract new traders through the auction process to daily post a standing maximum bid for all standard trade products and specify total maximum commodities & futures desired in each maturity category, as well as any desired geographic limitations and a selected maximum interest rate. When a trader indicates a desire to offer commodities & futures via the auction process, the network will automatically notify the trading houses meeting the trader's criteria and commence an automated auction with the trader's commodities & futures being rewarded to the winning bidder. If there is a tie, the trader selects the winning trading house.

### Risk Analytics

Several disclosed embodiments, and some claims, of the present disclosure specify the utilization of risk analytics. Common quantitative factors used in risk analytics include return on assets (ROA), return on equity (ROE), net income, assets, trades, other liabilities, and equity. The trades-to-assets ratio is another quantitative factor often used in performing risk analytics. A trading house's trades-to-assets ratio provides insight into how the trading house seeks to generate income and insulate itself from risk.

For risk analytic purposes, trading house assets are typically divided between trade and lease assets and other assets. Trade and lease assets typically include agriculture trades, commercial and industrial trades, real estate trades, credit card trades, other consumer trades, municipal trades, foreign government trades, tradery institution trades, commercial real estate trades, misc. trades, executive officer trades, and leases.

All references, including publications, patent applications, and patents, cited herein are hereby incorporated by reference to the same extent as if each reference were individually and specifically indicated to be incorporated by reference and were set forth in its entirety herein. The use of the terms “a” and “an” and “the” and similar referents in the context of describing the disclosure (especially in the context of the following claims) are to be construed to cover both the singular and the plural, unless otherwise indicated herein or clearly contradicted by context.

The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context. For example, the disclosure refers to trading house-to-trading house transactions, but one of skill in the art would appreciate that the inventor intends that the traders referred to in the disclosure and the claims may be a business. Likewise, those having skill in the relevant art would appreciate that the trader could be a consumer. Therefore, the phrase “trading house-to-trading house” as used herein includes “trading house-to-trading house,” “business-to-trading house,” and “consumer-to-trading house.” Similarly, the term “trading house” as used herein can mean “commercial trading house,” or other types of “trading houses.” Furthermore, trader criteria can include, for example, $ amount, product term, product timeframe, qualifications of bidding trading houses (such as size, capital, demographics, U.S., foreign, etc.), insured vs. uninsured trades, and time for close of bid. Similarly, trading house criteria can include, for example, $ amount, product term, product timeframe, qualifications for potential traders (such as demographics, U.S., foreign, etc.), maximum rate to be paid, and insured vs. uninsured trades. Throughout this disclosure, the auction process has the potential to arrive at a single winning bid. In some embodiments, part of that process may include the selection of a winning bid by the auction initiator, when the auction process has identified more than one winning bid. For example, in some embodiments, if a trader initiates a trade auction, and the auctioneer produces more than one winning trading house, the trader then chooses between the winning trading houses where it will trade its commodities & futures.

What is claimed is:

1. A method for auctioning commodities & futures to a trading house using a full-time public network, including the steps of:
establishing a connection to a full-time public network;
accepting trading house criteria received via the full-time public network;
performing risk analytics to facilitate identification of acceptable bidders;
accepting at least one bid from at least one acceptable bidder via the full-time public network;
evaluating each accepted bid based on the trading house criteria to determine whether the bid satisfies the criteria; and
selecting as a winning bid at least one bid determined to satisfy the trading house criteria.

2. The method of claim 1, further including the steps of:
notifying the trading house of the winning bidder's identity; and
notifying the winning bidder of the trading house's identity.

3. The method of claim 2, further including the step of:
facilitating the transfer of commodities & futures from the winning bidder to the trading house according to the terms of the trading house criteria and the winning bid.

4. The method of claim 1, wherein the trading house criteria includes a term.

5. The method of claim 1, wherein the trading house criteria includes a range of acceptable interest rates.

6. The method of claim 1, wherein the trading house criteria includes information pertaining to acceptable risk.

7. A method for auctioning commodities & futures by a trader using a full-time public network, including the steps of:
establishing a connection to a full-time public network;
accepting trader criteria received via the full-time public network;
performing risk analytics to facilitate identification of acceptable bidders;
accepting at least one bid from at least one acceptable bidder via the full-time public network;
evaluating each accepted bid based on the trader criteria to determine whether the bid satisfies the criteria; and
selecting as a winning bid at least one bid determined to satisfy the trader criteria.

8. The method of claim 7, further including the steps of:
notifying the trader of the winning bidder's identity; and
notifying the winning bidder of the trader's identity.

9. The method of claim 8, further including the step of:
facilitating the transfer of commodities & futures from the trader to the winning bidder according to the terms of the trader criteria and the winning bid.

10. The method of claim 7, wherein the trader criteria includes:
a term; and
a range of acceptable interest rates.

11. The method of claim 7, wherein the trader criteria includes information pertaining to acceptable risk.

12. The method of claim 7, wherein the trade criteria are non-standard compared to typical industry practices.

13. The method of claim 12, further comprising the step of:
apprising member trading houses of the non-standard trade criteria.

14. The method of claim 7, wherein the step of accepting at least one bid from at least one acceptable bidder via the full-time public network comprises the step of:
reviewing at least one unfulfilled standing bid to determine whether the unfulfilled standing bid satisfies the trade criteria; and
automatically accepting unfulfilled standing bids that satisfy the trade criteria.

15. A system for auction-based transactional matching of traders and trading houses in order to achieve qualified placement of commodities & futures so as to satisfy the criteria of trader and trading house, the system comprising:
at least one trader computing system adapted to communicably couple to an auctioneer computing system via the full-time public network;
at least one trading house computing system adapted to communicably couple to the auctioneer computing system via the full-time public network;
the auctioneer computing system adapted to communicably couple to the full-time public network, wherein the auctioneer computing system comprises:
a trader criteria module adapted to accept trader criteria from potential traders via the full-time public network;
a trading house criteria module adapted to accept trading house criteria from potential traders via the full-time public network;
an auction module adapted to perform an auction-based transactional matching of accepted trader criteria to accepted trading house criteria, wherein each criteria satisfies the requirements of the criteria to which it is matched;
a notification module adapted to notify, in response to the matching of an accepted trader criteria with an accepted trading house criteria, the corresponding trader and the corresponding trading house of the match via the full-time public network;
wherein the at least one trader computing system is adapted to communicably couple to the at least one trading house computing system following conclusion of the auction-based match in order to execute post-auction activity in accordance with the terms of the trader criteria and the trading house criteria.

16. The system of claim 15, wherein the auctioneer computing system further comprises:
a risk analytic module adapted to perform risk analytics on accepted trader criteria and accepted trading house criteria in order to facilitate matching.

17. The system of claim 15, wherein the risk analytic module comprises computer-readable instructions, the execution of which perform the step of:
performing risk analytics on accepted trader criteria and accepted trading house criteria in order to facilitate matching.

18. The system of claim 15, wherein the trader criteria module comprises computer-readable instructions, the execution of which perform the step of:
accepting trader criteria from potential traders via the full-time public network.

19. The system of claim 15, wherein the trading house criteria module comprises computer-readable instructions, the execution of which perform the step of:
accepting trading house criteria from potential traders via the full-time public network.

20. The system of claim 15, wherein the auction module comprises computer-readable instructions, the execution of which perform the step of:
performing an auction-based transactional matching of accepted trader criteria to accepted trading house criteria, wherein each criteria satisfies the requirements of the criteria to which it is matched.

21. A method for auctioning trading house trade opportunities to traders using a full-time public network, including the steps of:
establishing a connection to a full-time public network;
accepting trading house trade criteria received from a trading house via the full-time public network, including:
a trade amount;
a trade term;
a maximum specified interest rate;
accepting at least one bid from at least one trader via the full-time public network, the bid including a bid interest rate no more than the maximum specified interest rate;
selecting at least one winning bid from the accepted bids on the basis of its bid interest rate; and
notifying the trading house of the winning bid, including the identity of the winning bidder and the winning bid interest rate.

22. The method of claim 21, further including the steps of:
notifying the winning trader of the trading house's identity.

23. The method of claim 22, further including the step of:
facilitating the transfer of commodities & futures from the winning trader to the trading house to fulfill the trading house trade opportunity according to the terms of the trading house trade criteria and the winning bid.
